(19) United States
(12) Patent Application Publication
(10) Pub. No.: US 2008/0013768 A1
(43) Pub. Date: Jan. 17, 2008

(54) Loudspeaker Enclosure and Loudspeaker System

(75) Inventor: Toyofumi Hayashi, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 11/770,875

(22) Filed: Jun. 29, 2007

(30) Foreign Application Priority Data
Jun. 30, 2006 (JP) 2006-182303

(51) Int. Cl. H04R 1/20

(52) U.S. Cl. 381/337

(57) ABSTRACT

A loudspeaker enclosure includes a first sound wave guiding portion that partitions a first space which is separated by one face of a diaphragm of a loudspeaker and has a first opening portion, and a second sound wave guiding portion that partitions a second space which is separated by the other face of the diaphragm of the loudspeaker and has a second opening portion. The second opening portion of the second sound wave guiding portion is provided around the first opening portion of the first sound wave guiding portion. A position of the second opening portion of the second sound wave guiding portion is set so that a second sound wave emitted from the second opening portion of the second sound wave guiding portion is emitted in a direction to suppress a spread of a first sound wave emitted from the first opening portion of the first sound wave guiding portion.

### BACKGROUND OF THE INVENTION

The present invention relates to a loudspeaker enclosure and a loudspeaker system capable of improving a directivity of a loudspeaker.

As the loudspeaker system capable of enhancing the directivity, i.e., the loudspeaker system having the so-called narrow directivity, there is the loudspeaker array, for example. The loudspeaker array enhances the directivity by controlling respective amplitudes and phases in individual loudspeakers. The system using the loudspeaker array tends to increase in size because a plurality of loudspeakers are used, however, for example, in JP-A-2006-101464, such a technology is disclosed that, because a hood is fitted in front of a loudspeaker and also the loudspeaker is arranged at a focal point of a sound reflecting inner wall of the hood, the directivity can be enhanced even in a small-sized loudspeaker.

The loudspeaker with the hood can enhance the directivity even in the small-sized loudspeaker, nevertheless such loudspeaker has the problem the directivity is deteriorated because a sound diffracts at an edge portion of an opening portion of the hood. In JP-A-2006-101464, in order to solve this problem, the technology of providing a glass wool having a sound absorbing function along the edge portion of the opening portion of the hood is disclosed. As a result, a size of the loudspeaker is increased. Also, a sound emitted from a rear surface of a diaphragm of the loudspeaker is forcedly attenuated by using the glass wool not to leak. Therefore, such arrangement similarly constitutes a factor that increases a size of the loudspeaker.

### SUMMARY OF THE INVENTION

The present invention has been made in view of the above circumstances, and it is an object of the present invention to provide a loudspeaker enclosure and a loudspeaker system capable of reducing a size and improving a directivity.

In order to solve the above problems, the present invention provides a loudspeaker enclosure, comprising:

a first sound wave guiding portion that partitions a first space which is separated by one face of a diaphragm of a loudspeaker and has a first opening portion; and

a second sound wave guiding portion that partitions a second space which is separated by the other face of the diaphragm of the loudspeaker and has a second opening portion,

wherein the second opening portion of the second sound wave guiding portion is provided around the first opening portion of the first sound wave guiding portion; and

wherein a position of the second opening portion of the second sound wave guiding portion is set so that a second sound wave emitted from the second opening portion of the second sound wave guiding portion is emitted in a direction to suppress a spread of a first sound wave emitted from the first opening portion of the first sound wave guiding portion.

Also, the present invention provides a loudspeaker system, comprising:

a loudspeaker;

a first sound wave guiding portion that partitions a first space which is separated by one face of a diaphragm of a loudspeaker and has a first opening portion; and

a second sound wave guiding portion that partitions a second space which is separated by the other face of the diaphragm of the loudspeaker and has a second opening portion,

wherein the second opening portion of the second sound wave guiding portion is provided around the first opening portion of the first sound wave guiding portion; and

wherein a position of the second opening portion of the second sound wave guiding portion is set so that a second sound wave emitted from the second opening portion of the second sound wave guiding portion is emitted in a direction to suppress a spread of a first sound wave emitted from the first opening portion of the first sound wave guiding portion.

Preferably, the first space is separated by one faces of diaphragms of a plurality of loudspeakers. The second space is separated by the other faces of the diaphragms of the loudspeakers.

Preferably, at least one of the first sound wave guiding portion and the second sound wave guiding portion has a light source.

Here, it is preferable that, at least one of the first sound wave guiding portion and the second sound wave guiding portion is formed of light transmitting material.

Preferably, the loudspeaker has an acoustic lens.

Preferably, the first sound wave emitted from the first opening portion through the first sound wave guiding portion is opposite in phase to the second sound wave emitted from the second opening portion through the second sound wave guiding portion.

According to the present invention, a diffraction sound generated at an edge portion of an opening portion when a sound wave is emitted from the opening portion of the enclosure can be reduced. Therefore, the loudspeaker enclosure can be reduced small in size and can improve the directivity.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an external appearance view of an enclosure according to a first embodiment of the present invention;

FIG. 2 is a sectional view of the enclosure according to the first embodiment of the present invention;

FIG. 3 is an external appearance view of an internal structural body of the enclosure according to the first embodiment of the present invention;

FIG. 4 is a sectional view of a neighborhood of a loudspeaker that is installed in the enclosure according to the first embodiment of the present invention;

FIG. 5 is a conceptual view of actions of a sound wave in an interior of the enclosure according to the first embodiment of the present invention;

FIG. 6 is an external appearance view of an enclosure according to a second embodiment of the present invention;

FIG. 7 is a sectional view of the enclosure according to the second embodiment of the present invention;

FIG. 8 is an external appearance view of an upper structural body of the enclosure according to the second embodiment of the present invention;

FIG. 9 is an external appearance view of an inner structural body of the enclosure according to the second embodiment of the present invention;

FIG. 10 is a sectional view of a neighborhood of a loudspeaker that is installed in the enclosure according to the second embodiment of the present invention;

FIG. 11 is a conceptual view of actions of a sound wave in an interior of the enclosure according to the second embodiment of the present invention;

FIG. 12 is a sectional view of a neighborhood of a loudspeaker that is installed in an enclosure according to a variation 1 of the present invention;

FIG. 13 is a sectional view of an enclosure according to the variation 1 of the present invention;

FIG. 14 is a sectional view of an enclosure according to a variation 2 of the present invention;

FIG. 15 is a sectional view of an enclosure according to a variation 4 of the present invention;

FIG. 16 is an external appearance view of an enclosure according to a variation 5 of the present invention; and

FIG. 17 is a sectional view of the enclosure according to the variation 5 of the present invention.

### DETAILED DESCRIPTION OF THE PREFERRED EMBODIMENTS

Embodiments of the present invention will be explained hereinafter.

### First Embodiment

FIG. 1 is an external appearance view showing an external appearance of a loudspeaker enclosure 1 as a first embodiment of the present invention. The enclosure 1 has an upper structural body 2 shaped into a frustum of circular cone that widens toward a bottom, and a lower structural body 3 shaped into a frustum of circular cone that narrows toward a bottom. A lower end outer edge of the upper structural body 2 and an upper end outer edge of the lower structural body 3 are joined together such that center axes of respective circular cones are aligned mutually.

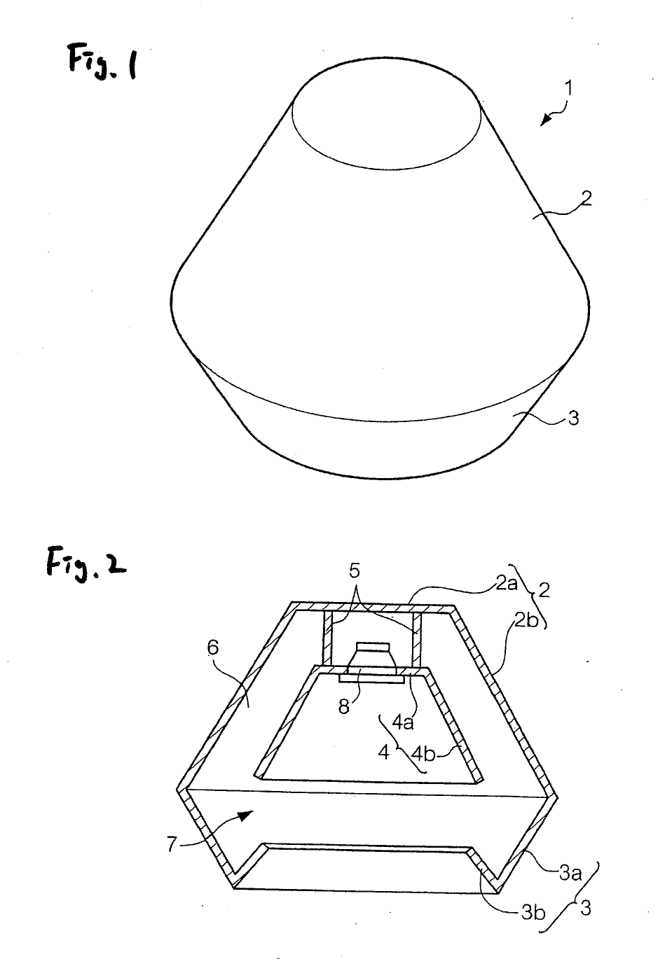

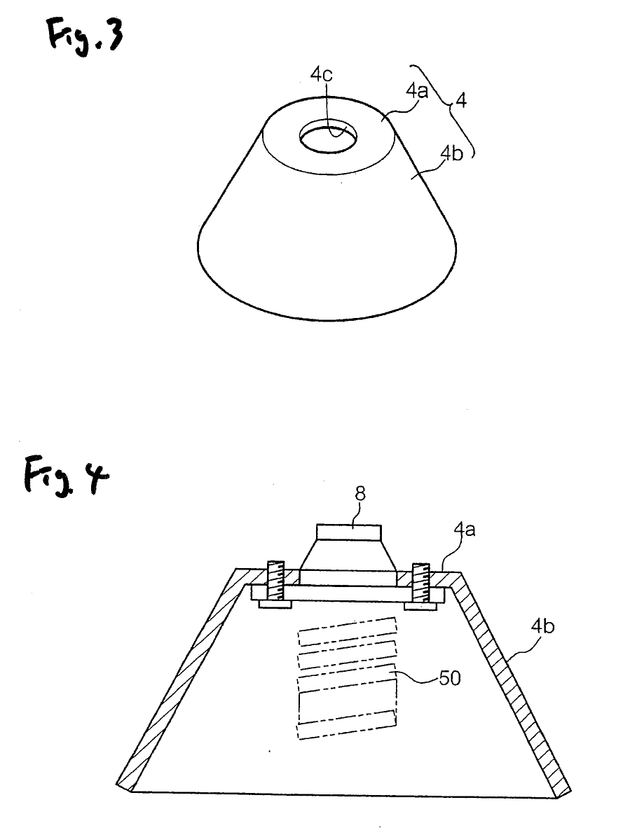

FIG. 2 is a sectional view of the enclosure 1 shown in FIG. 1 and shows a section when the enclosure 1 is cut by a plane containing the center axis of the frustum of circular cone. As shown in FIG. 2, the enclosure 1 is formed as a hollow structure. Also, the upper structural body 2 has an outer top plate 2a provided to its top end, and an outer wall 2b formed as a frustum of circular cone.

A lower end of the lower structural body 3 is opened, and the lower structural body 3 has a outer wall 3a shaped into a frustum of circular cone that narrows toward a bottom, and a projected wall 3b extending obliquely upward from a lower end of the outer wall 3a. Here, the projected wall 3b is formed in a position that cannot be seen from the direction shown in FIG. 1.

An internal structural body 4 shaped into a frustum of circular cone that widens toward a bottom to have a shape similar to the upper structural body 2 is provided in the inside of the enclosure 1. The internal structural body 4 has an inner top plate 4a provided to its top end, and an inner wall 4b shaped into a frustum of circular cone that widens toward an opened bottom.

FIG. 3 is an external appearance view of an external appearance of the internal structural body 4 shown in FIG. 2. A loudspeaker installing hole 4c is opened in a center portion of the inner top plate 4a. The internal structural body 4 is supported by rod-like struts 5, 5 in such a manner that it is hung from the outer top plate 2a.

As shown in FIG. 4, a loudspeaker 8 is fitted into the loudspeaker installing hole 4c from the lower surface side of the inner top plate 4a.

A duct 6 (second sound wave guiding portion) is constructed by inner peripheral surfaces of the upper structural body 2 and the lower structural body 3 and an outer peripheral surface of the internal structural body 4. The duct 6 constitutes an opening portion 7 between a lower end portion of the inner wall 4b and an upper end portion of the projected wall 3b.

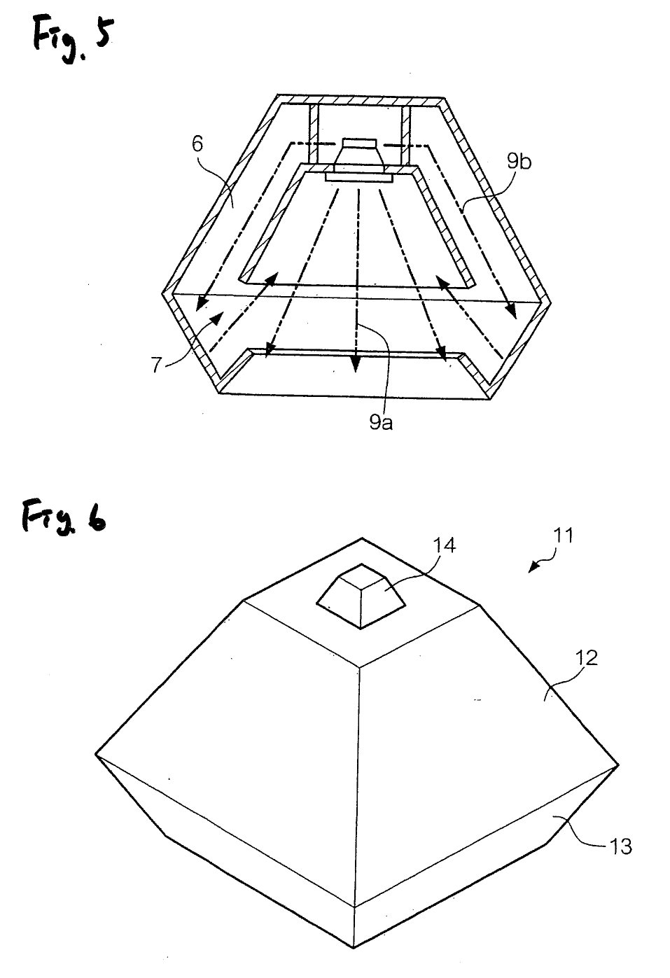

FIG. 5 is a view showing a state that the loudspeaker 8 is driven in the above structure. When the loudspeaker 8 is driven, a sound wave 9a emitted from a front face of a diaphragm (normally a cone paper) of the loudspeaker 8 is passed through a space surrounded with the internal structural body 4 (first sound wave guiding portion), and is emitted outward through an opening portion formed at the bottom of the lower structural body 3.

In contrast, a sound wave 9b emitted from a rear face of the diaphragm of the loudspeaker 8 propagates through the duct 6 and arrives at the opening portion 7. Then, the sound wave 9b emitted from a rear face of the diaphragm is emitted in the direction to suppress a spread of the sound wave that is emitted through the opening portion of the internal structural body 4. In this case, since the sound wave 9b emitted from the rear face of the diaphragm is opposite in phase to the sound wave 9a emitted from the front face of the diaphragm, the sound waves interfere mutually around the opening portion 7 to lower a sound pressure there. As a result, an amount of diffraction of the sound at the opening portion of the enclosure 1 is reduced, and the directivity of the sound toward the bottom side of a frustum of circular cone of the enclosure 1 along a center axis can be improved.

### Second Embodiment

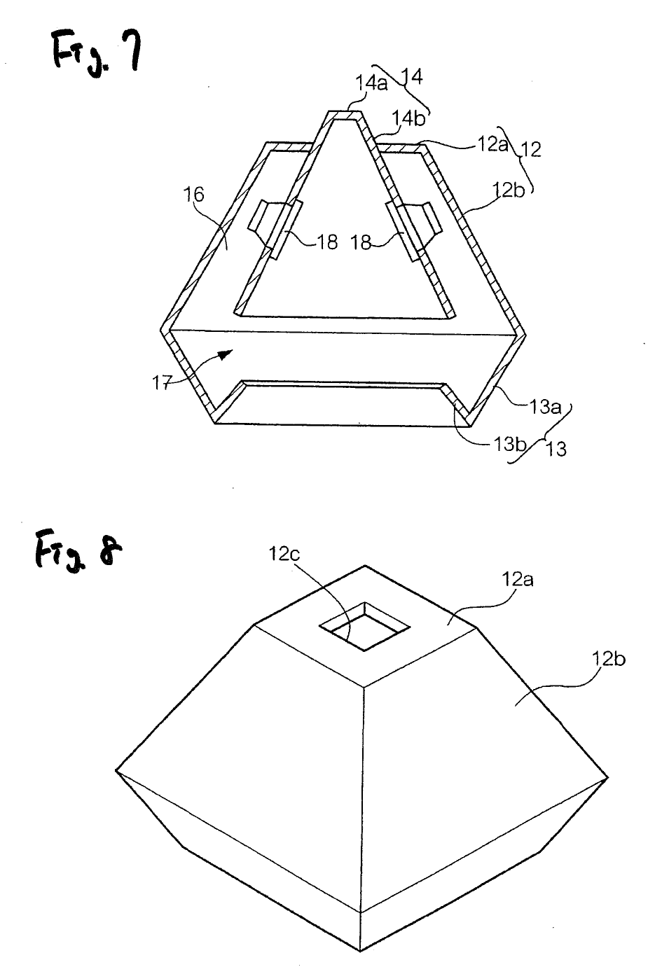

FIG. 6 is an external appearance view showing of an external appearance of a loudspeaker enclosure 11 according to a second embodiment of the present invention. The enclosure 11 has an upper structural body 12 shaped into a frustum of quadrangular pyramid that widens toward a bottom, a lower structural body 13 shaped into a frustum of quadrangular pyramid that narrows toward a bottom, and an internal structural body 14 shaped into a frustum of quadrangular pyramid that widens toward a bottom. The internal structural body 14 projects from an interior of the upper structural body 12 to the outer side via an upper surface of the upper structural body 12, and these bodies are joined together in such a manner that center axes of respective frustums of quadrangular pyramid are aligned mutually. Also, a lower end outer edge of the upper structural body 12 and an upper end outer edge of the lower structural body 13 are joined together in such a manner that center axes of respective frustums of quadrangular pyramid are aligned mutually.

FIG. 7 is a sectional view of the enclosure 11 shown in FIG. 6, and shows a section when the enclosure 11 is cut by a plane containing a center axis of the frustum of quadrangular pyramid and a center point of a base of the quadrangular pyramid. As shown in FIG. 7, the enclosure 11 is formed as a hollow structure. Also, the upper structural body 12 has an outer top plate 12a provided to its top end, and an outer wall 12b shaped into a frustum of quadrangular pyramid.

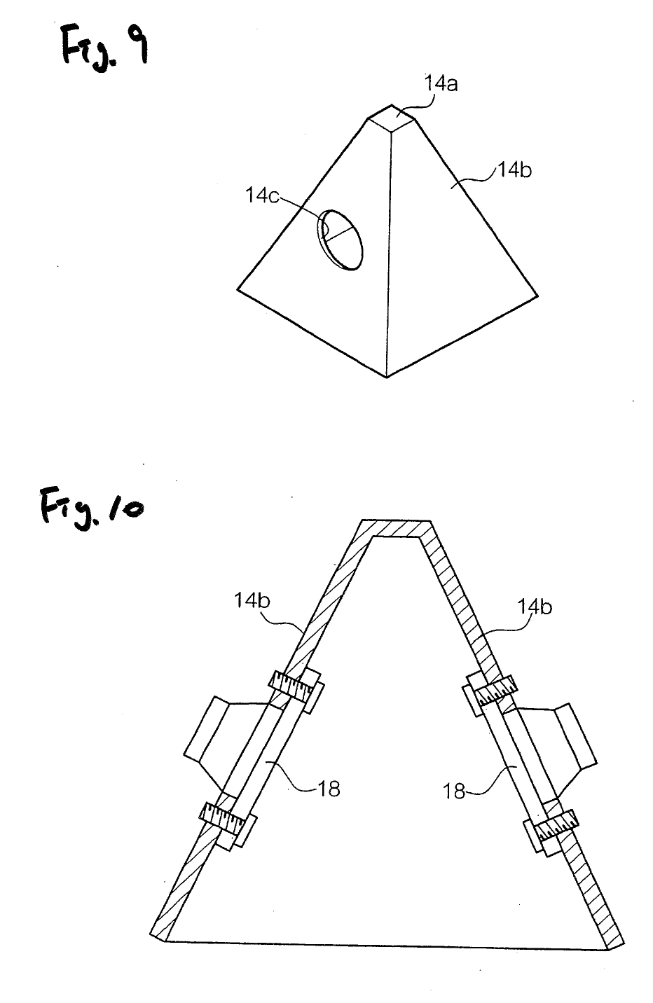

FIG. 8 is an external appearance view showing an external appearance of the upper structural body 12 shown in FIG. 7. An inner structural body projecting hole 12c is opened in a center portion of the outer top plate 12a.

A lower end of the lower structural body 13 is opened, and the lower structural body 13 has an outer wall 13a shaped into a frustum of quadrangular pyramid that narrows toward a bottom, and a projected wall 13b extending obliquely upward from a lower end of the outer wall 13a. Here, the projected wall 13b is formed in a position that cannot be seen from the direction shown in FIG. 6.

The internal structural body 14 has an inner top plate 14a provided to its top end, and an inner wall 14b shaped into a frustum of quadrangular pyramid that widens toward an opened bottom.

FIG. 9 is an external appearance view showing an external appearance of the inner structural body 14 shown in FIG. 7. A loudspeaker installing hole 14c are provided in a center portion of the above inner wall 14b. Also, another loudspeaker installing hole 14c is provided in the opposing inner wall 14b that cannot be seen from the direction shown in FIG. 9. Accordingly, two loudspeakers are provided to the inner structural body 14 (see FIG. 7).

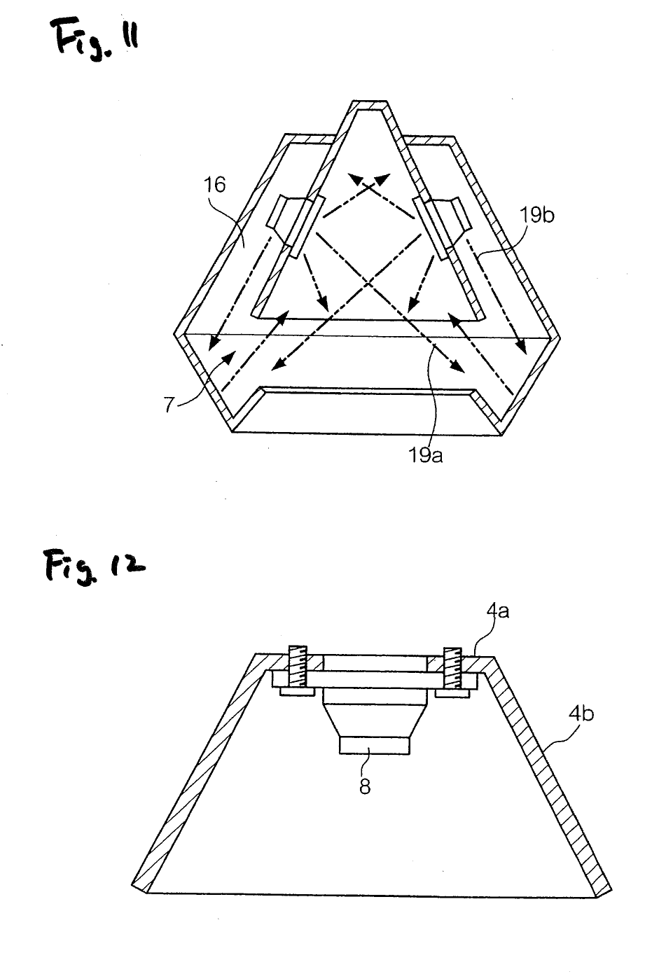

As shown in FIG. 10, a loudspeaker 18 is fitted into the loudspeaker installing hole 14c from the inner surface side of the inner wall 14b.

The inner structural body 14 projects to the outside from an inner side of the upper structural body 12 through the inner structural body projecting hole 12c that is opened in the outer top plate 12a. The outer top plate 12a and the inner wall 14b are joined tightly on a periphery of the inner structural body projecting hole 12c.

A duct 16 (second sound wave guiding portion) is formed by inner peripheral surfaces of the upper structural body 12 and the lower structural body 13 and an outer peripheral surface of a not-projected portion of the inner structural body 14. The duct 16 constitutes an opening portion 17 between the lower end portion of the inner wall 14b and the top end portion of the projected wall 13b.

FIG. 11 is a view showing a state that the loudspeaker 18 is driven in the above configuration. When the loudspeaker 18 is driven, a sound wave 19a emitted from a front face of a diaphragm of the loudspeaker 18 is passed through a space surrounded with the internal structural body 14 (first sound wave guiding portion), and is emitted outward through an opening portion formed at the bottom of the lower structural body 13.

In contrast, a sound wave 19b emitted from a rear face of the diaphragm of the loudspeaker 18 propagates through the duct 16 and arrives at the opening portion 17. Then, the sound wave 19b emitted from a rear face of the diaphragm is emitted in the direction to suppress a spread of the sound wave that is emitted through the opening portion of the internal structural body 14. In this case, since the sound wave 19b emitted from the rear face of the diaphragm is opposite in phase to the sound wave 19a emitted from the front face of the diaphragm, the sound waves interfere mutually around the opening portion 17 to lower a sound pressure there. As a result, an amount of diffraction of the sound at the opening portion of the enclosure 11 is reduced, and the directivity of the sound toward the bottom side of a frustum of quadrangular pyramid of the enclosure 11 along a center axis can be improved.

### <Variation 1>

With the above, embodiments of the present invention are explained. But the present invention can be carried out in various modes given as follows.

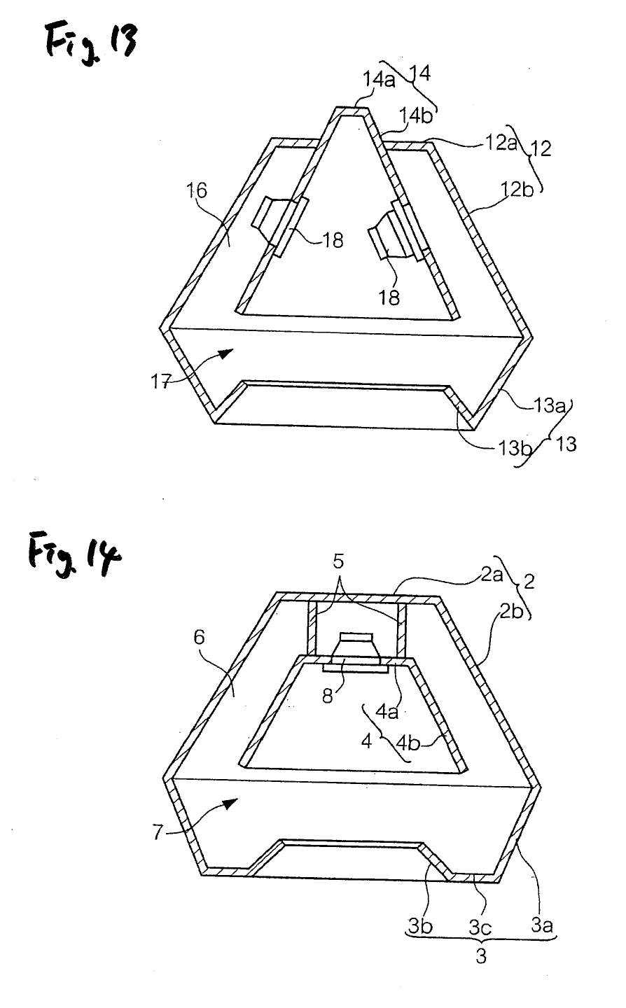

In the first embodiment, the sound wave 9a emitted from the front face of the diaphragm of the loudspeaker 8 is emitted into a space surrounded with the internal structural body 4, while the sound wave 9b emitted from the rear face of the diaphragm of the loudspeaker 8 is emitted into the duct 6. In a variation 1, the sound wave 9a emitted from the front face of the diaphragm of the loudspeaker 8 may be emitted into the duct 6, while the sound wave 9b emitted from the rear face of the diaphragm of the loudspeaker 8 may be emitted into the space surrounded with the internal structural body 4. In such case, as shown in FIG. 12, the loudspeaker 8 may be fitted in the opposite direction to that in the first embodiment.

Similarly, both two loudspeakers 18 may be fitted in the opposite direction mutually, as in the second embodiment. Alternately, as shown in FIG. 13, only one loudspeaker 18 may be fitted in the opposite direction. When only one loudspeaker 18 is fitted in the opposite direction, respective loudspeakers 18 may be driven in an opposite phase mutually.

### <Variation 2>

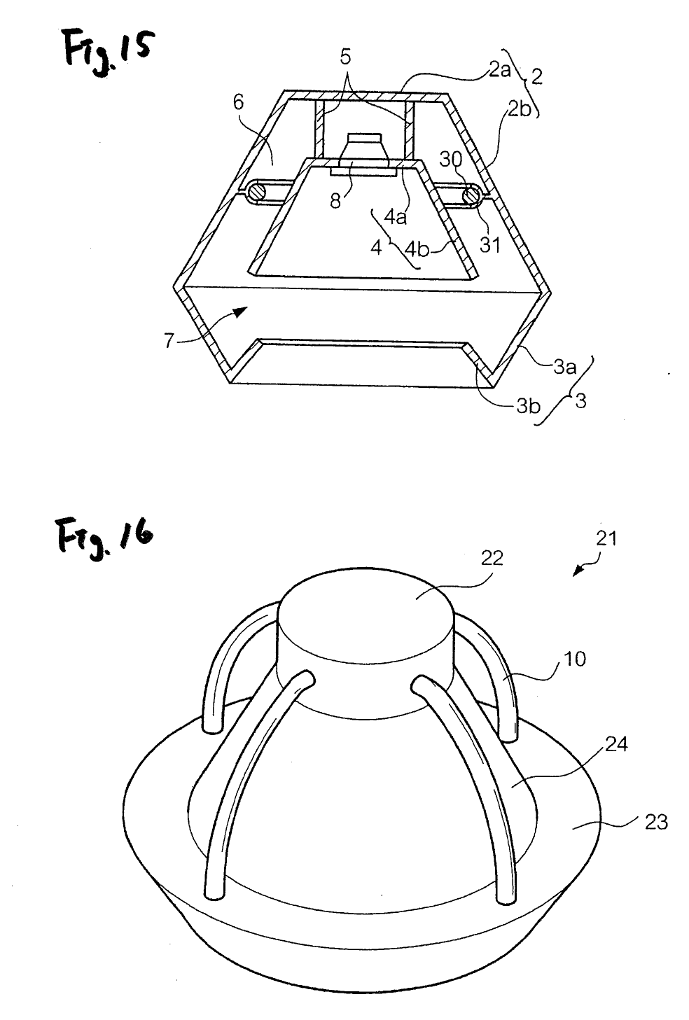

In the first embodiment, the lower end of the lower structural body 3 is opened, and the lower structural body 3 has the outer wall 3a shaped into the frustum of circular cone that narrows toward the bottom, and the projected wall 3b extending obliquely upward from the lower end of the outer wall 3a. In a variation 2, as shown in FIG. 14, the lower structural body 3 may be constructed to have the outer wall 3a shaped into the frustum of circular cone that narrows toward the bottom, a lower wall 3c extending in the horizontal direction from the lower end of the outer wall 3a, and the projected wall 3b extending obliquely upward from the end portion of the lower wall 3c. That is, a bending of the duct 6 is made gentle by adding the lower wall 3c as another wall between the outer wall 3a and the projected wall 3b in the first embodiment, so that a sound wave propagating through the duct 6 is be guided smoothly to the opening portion 7. In addition, in order to render the bending of the duct 6 gentle, an angle between adjacent walls at a boundary portion may be increased by constructing the lower wall 3c by means of plural sheets of walls. Also, respective walls may be constructed by a curved surface to eliminate an angle at the boundary portion, and also a curvature of the duct 6 can be made smooth when respective walls are constructed by a curved surface.

### <Variation 3>

As indicated by a broken line in FIG. 4, a converging type acoustic lens 50 may be arranged to the front face of the loudspeaker 8 on the sound wave emission side in the first embodiment. With this arrangement, the directivity of the sound wave emitted from the loudspeaker can be increased much more in the width direction of the acoustic lens 50.

### <Variation 4>

In the first embodiment, the enclosure of the present invention can be used as a luminaire by installing a light source to the enclosure 1. Also, when a light source is installed into the inside of the enclosure 1, this enclosure can be used as a pendant type luminaire. Thus, the user can listen a sound from the loudspeaker 8 in an illuminated area and its vicinity.

As a situation that a light source is installed in the inside of the enclosure 1, for example, as shown in FIG. 15, an annulus light source 30 is installed in the duct 6. The light source 30 is secured to the outer wall 2b by a supporting body 31. In this case, a part or all of the inner wall 4b should be formed of a light transmitting material.

### <Variation 5>

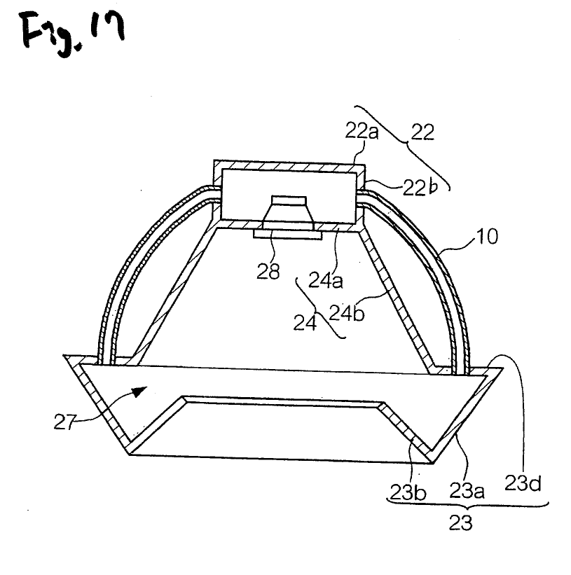

FIG. 16 is an external appearance view showing an external appearance of a loudspeaker enclosure 21 according to a variation 5 of the present invention. The enclosure 21 has a cylindrical upper structural body 22, an internal structural body 24 shaped into a frustum of circular cone that widens toward a bottom, a lower structural body 23 shaped into a frustum of circular cone that narrows toward a bottom, and a tube 10. A lower end outer edge of the upper structural body 22 and an upper end outer edge of the internal structural body 24 or a lower end outer edge of the internal structural body 24 and an upper end inner edge of the lower structural body 23 are joined together such that center axes of respective structural bodies are aligned mutually.

FIG. 17 is a sectional view of the enclosure 21 shown in FIG. 16, and shows a section when the enclosure is cut by a plane containing respective center axes. The upper structural body 22 has an outer top plate 22a provided to its top end, and a cylindrical outer wall 22b. Here, holes that are connected to the tubes 10 are opened in the outer wall 22b.

A lower end of the lower structural body 23 is opened, and the lower structural body 23 has an outer wall 23a shaped into a frustum of circular cone that narrows toward a bottom, a projected wall 23b extending obliquely upward from a lower end of the outer wall 23a, and an upper wall 23d extending from a top end of the outer wall 23a in the horizontal direction. Here, holes that are connected to the tubes 10 are opened in the upper wall 23d. This projected wall 23b is formed in a position that cannot be seen from the direction shown in FIG. 16.

The internal structural body 24 has an inner top plate 24a provided to its top end, and an inner wall 24b shaped into a frustum of circular cone that widens toward an opened bottom. A loudspeaker 28 is fitted to the inner top plate 24a.

The upper structural body 22 and the lower structural body 23 are connected via the tubes 10. Also, an opening portion 27 is formed between the lower end portion of the inner wall 24b and the top end portion of the projected wall 23b.

In operation of the above configuration, the sound wave emitted from the rear face of the diaphragm of the loudspeaker 28 propagates through the tubes 10, and is emitted from the opening portion 27. Therefore, the similar advantages to those of the first embodiment can be achieved, and a reduction in size and weight can be attained further more.

In this case, the variations though explained by using the first embodiment can also be applied to the second embodiment and other variations.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2006-182303 filed on Jun. 30, 2006, the contents of which are incorporated herein for reference.

What is claimed is:

1. A loudspeaker enclosure, comprising:
a first sound wave guiding portion that partitions a first space which is separated by one face of a diaphragm of a loudspeaker and has a first opening portion; and
a second sound wave guiding portion that partitions a second space which is separated by the other face of the diaphragm of the loudspeaker and has a second opening portion,
wherein the second opening portion of the second sound wave guiding portion is provided around the first opening portion of the first sound wave guiding portion; and
wherein a position of the second opening portion of the second sound wave guiding portion is set so that a second sound wave emitted from the second opening portion of the second sound wave guiding portion is emitted in a direction to suppress a spread of a first sound wave emitted from the first opening portion of the first sound wave guiding portion.

2. The loudspeaker enclosure according to claim 1, wherein the first space is separated by one faces of diaphragms of a plurality of loudspeakers; and
wherein the second space is separated by the other faces of the diaphragms of the loudspeakers.

3. The loudspeaker enclosure according to claim 1, wherein at least one of the first sound wave guiding portion and the second sound wave guiding portion has a light source.

4. The loudspeaker enclosure according to claim 3, wherein at least one of the first sound wave guiding portion and the second sound wave guiding portion is formed of light transmitting material.

5. The loudspeaker enclosure according to claim 1, wherein the first sound wave emitted from the first opening portion through the first sound wave guiding portion is opposite in phase to the second sound wave emitted from the second opening portion through the second sound wave guiding portion.

6. A loudspeaker system, comprising:
a loudspeaker;
a first sound wave guiding portion that partitions a first space which is separated by one face of a diaphragm of a loudspeaker and has a first opening portion; and
a second sound wave guiding portion that partitions a second space which is separated by the other face of the diaphragm of the loudspeaker and has a second opening portion,
wherein the second opening portion of the second sound wave guiding portion is provided around the first opening portion of the first sound wave guiding portion; and
wherein a position of the second opening portion of the second sound wave guiding portion is set so that a second sound wave emitted from the second opening portion of the second sound wave guiding portion is emitted in a direction to suppress a spread of a first sound wave emitted from the first opening portion of the first sound wave guiding portion.

7. The loudspeaker system according to claim 6, wherein the first space is separated by one faces of diaphragms of a plurality of loudspeakers; and
wherein the second space is separated by the other faces of the diaphragms of the loudspeakers.

8. The loudspeaker system according to claim 6, wherein at least one of the first sound wave guiding portion and the second sound wave guiding portion has a light source.

9. The loudspeaker system according to claim 8, wherein at least one of the first sound wave guiding portion and the second sound wave guiding portion is formed of light transmitting material.

10. The loudspeaker system according to claim 6, wherein the loudspeaker has an acoustic lens.

11. The loudspeaker system according to claim 6, wherein the first sound wave emitted from the first opening portion through the first sound wave guiding portion is opposite in phase to the second sound wave emitted from the second opening portion through the second sound wave guiding portion.
